(19) United States
(12) Patent Application Publication
(10) Pub. No.: US 2023/0070674 A1
(43) Pub. Date: Mar. 9, 2023

(54) SYSTEM FOR OBLIGATION EXTRACTION AND POPULATION WITH REAL-TIME PRE-ENDORSEMENT MATRIX

(71) Applicant: BANK OF AMERICA CORPORATION, Charlotte, NC (US)

(72) Inventors: Robertson Walters Greenbacker, Charlotte, NC (US); Justin Riley duPont, Charlotte, NC (US); Waldemar Zygmunt Mlynarski, JR., Marietta, GA (US)

(73) Assignee: BANK OF AMERICA CORPORATION, Charlotte, NC (US)

(21) Appl. No.: 17/466,152

(22) Filed: Sep. 3, 2021

(51) Int. Cl. G06Q 20/38; G06Q 20/24; G06Q 20/40; G06N 20/00

(52) U.S. Cl. CPC G06Q 20/389; G06Q 20/24; G06Q 20/4033; G06Q 20/401; G06N 20/00

(57) ABSTRACT

Embodiments of the invention are directed to systems, methods, and computer program products for a pre-endorsement decisioning matrix for adapted delayed trigger resource distribution programs. The invention utilizes machine learning to perform real-time obligation extraction and population with respect to adapted delayed trigger resource distribution programs. The matrix performs two functions with respect to adapted delayed trigger resource distributions. First, the system performs a right of real-time modification of an adapted delayed trigger resource distribution occurring between a user and product producer. Second, the system performs a right to extend product opportunities to a user bases on user historic adapted delayed trigger resource distribution obligation satisfaction.

### BACKGROUND

More and more providers are starting to use an adapted delayed trigger resource distribution method for delayed obligations. As this method is typically less regulated and requires less scrutiny. As such, if the obligations are not met, issuing entities and not providers may be susceptible. As such, a need exists for obligation extraction and population with a real-time pre-endorsement matrix.

### BRIEF SUMMARY

The following presents a simplified summary of one or more embodiments of the invention in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

Adapted delayed trigger resource distribution methods are a relatively new and small portion of resource transactions. However, adapted delayed trigger resource programs are gaining in popularity as a way to reduce a user's up-front obligation and spread that obligation over a period of time. Unlike loan products, adapted delayed trigger resource distribution programs are less regulated, do not require background confirmations, and are generally performed directly by the product provider. As such, financial institutions may be susceptible to adapted delayed trigger resource distribution program terms that are unknown. Furthermore, if obligations of the adapted delayed trigger resource distribution product are not met, the issuing institution associated with the resource distribution device may be susceptible. As such, a need exists for obligation extraction and population with a real-time pre-endorsement matrix.

The invention utilizes machine learning to perform an obligation extraction and population with real-time pre-endorsement matrix. The system performs two functions with respect to adapted delayed trigger resource distributions. First, the system performs a right of real-time modification of an adapted delayed trigger resource distribution occurring between a user and product producer. Second, the system performs a right to extend financial opportunities to a user bases on user historic adapted delayed trigger resource distribution obligation satisfaction.

In this way, the system utilized artificial intelligence (AI) in combination with machine learning analytics to perform approval, modification, denial of an adaptive delayed trigger resource requirement and provide future opportunities based on user adaptive delayed trigger resource requirement history. Issuing entities, such as financial institutions, currently do not monitor terms or obligations associated with adaptive delayed trigger resource requirement programs. Due to the fragmented nature of adaptive delayed trigger resource requirement program providers, managing adaptive delayed trigger resource requirement program obligations can become challenging, which may result in unexpected exposure for issuing entities and users.

Furthermore, the system may aggregate and estimate a user's obligations for adaptive delayed trigger resource requirement programs to determine users likely ability to perform the obligations. Furthermore, the system provides user alerts with respect to total adaptive delayed trigger resource requirement program obligations.

Embodiments of the invention relate to systems, methods, and computer program products for adapted delay trigger resource modification, the invention comprising: extracting historic and current user interval obligations, wherein user interval obligations include user adapted delayed trigger resource obligations; receiving, from a device associated with a first entity, data associated with an activity initiated by a user at a first time interval; in response to the activity initiated, identifying that the activity initiated is an adapted delayed trigger resource program initiation comprising an automated timer component structured to monitor an elapsed program time associated with the adapted delayed trigger resource; triggering a performance of a right of real-time modification of the adapted delayed trigger resource program; triggering performance of historic adapted delayed trigger resource obligation mapping; and processing, based on a pre-endorsement matrix mapping: the activity data based on the triggered performance of the right of real-time modification of the adapted delayed trigger resource program; and a modification to issuer product worthiness based on the triggered performance of historic adapted delayed trigger resource obligation mapping.

In some embodiments, processing, based on the pre-endorsement matrix mapping of the activity data without real-time modification of the adapted delay trigger resource program comprises: processing the activity data and complete the activity at a second time interval succeeding the first time interval based on not modifying the adapted delayed trigger resource program; and in response to determining that (i) the current elapsed program time associated with the adapted delayed trigger resource program is above a predetermined threshold, and (ii) the second time interval precedes the current elapsed program time, automatically trigger, via the adapted delayed trigger resource program, transmission of a resource quantity from a user resource to an entity resource at a third time interval succeeding the second time interval.

In some embodiments, triggering the performance of the right of real-time modification of the adapted delayed trigger resource program further comprises performing pre-endorsement matrix mapping analyzing: (i) extracted historic and current user interval obligations and (ii) the adapted delayed trigger resource program initiation to determine user resources available at a second time interval.

In some embodiments, based on performing the pre-endorsement matrix mapping analysis, confirm, modify, or deny the adapted delayed trigger resource program initiation in real-time.

In some embodiments, triggering the performance of historic adapted delayed trigger resource obligation mapping further comprises performing pre-endorsement matrix mapping analyzing user historic adapted delayed trigger resource obligation satisfaction.

In some embodiments, based on performing the pre-endorsement matrix mapping analysis, upgrade or downgrade user product worthiness.

In some embodiments, the pre-endorsement matrix mapping further comprises machine learning analysis of data for predicted user obligation fulfilment with respect to adapted delayed trigger resources.

In some embodiments, the first entity is a product producing entity that offers the adapted delayed trigger resource program to the user and provides terms associated with the adapted delayed trigger resource program.

In some embodiments, user interval obligations further comprise reoccurring resource distributions from the user to a third party for a product or service.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made to the accompanying drawings, wherein:

FIG. 1 illustrates an adapted delayed trigger resource matrix system environment, in accordance with one embodiment of the present disclosure;

FIG. 2 is a block diagram illustrating the adaptive delayed trigger resource system;

FIG. 3 is a block diagram illustrating a user device associated with the system environment;

FIG. 4 is a flow diagram illustrating a process of obligation extraction and population, in accordance with one embodiment of the present disclosure;

FIG. 5 is a flow diagram illustrating a process of modifying an adapted delayed trigger resource, in accordance with another embodiment of the present disclosure; and

FIG. 6 is a flow diagram illustrating a process of performance extension based on historic adapted delayed trigger resource, in accordance with another embodiment of the present disclosure.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to elements throughout. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein.

“Entity” or “managing entity” as used herein may refer to any organization, entity, or the like in the business of moving, investing, or lending money, dealing in financial instruments, or providing financial services. This may include commercial banks, thrifts, federal and state savings banks, savings and loan associations, credit unions, investment companies, insurance companies and the like. In some embodiments, the entity may allow a user to establish an account with the entity. An “account” may be the relationship that the user has with the entity. Examples of accounts include a deposit account, such as a transactional account (e.g., a banking account), a savings account, an investment account, a money market account, a time deposit, a demand deposit, a pre-paid account, a credit account, or the like. The account is associated with and/or maintained by the entity. In other embodiments, an entity may not be a financial institution. In still other embodiments, the entity may be the merchant itself.

“Entity system” or “managing entity system” as used herein may refer to the computing systems, devices, software, applications, communications hardware, and/or other resources used by the entity to perform the functions as described herein. Accordingly, the entity system may comprise desktop computers, laptop computers, servers, Internet-of-Things (“IoT”) devices, networked terminals, mobile smartphones, smart devices (e.g., smart watches), network connections, and/or other types of computing systems or devices and/or peripherals along with their associated applications.

“User” as used herein may refer to an individual or individual associated with an entity. As such, in some embodiments, the user may be an individual having past relationships, current relationships or potential future relationships with an entity. In some instances, a “user” is an individual who has a relationship with the entity, such as a customer or a prospective customer. In some instances described herein, the user is an individual who seeks to utilize, operate, or perform one or more activities associated with a computer terminal, typically based on successful validation of the user's authentication credentials. In other embodiments, a user may be a system or an entity performing one or more tasks described herein. Accordingly, as used herein the term “user device” or “mobile device” may refer to mobile phones, personal computing devices, tablet computers, wearable devices, and/or any portable electronic device capable of receiving and/or storing data therein.

“User actions” as used herein includes user typing gait, typing speed, touch screen pressure, user touch screen gait, angle of viewing of user devices, historic passwords, historic pins, user location and activity at those locations with respect to resource distributions, and the like. “User activity” includes the user of the user action to perform a function, such as logging in, authenticating, performing a transaction, performing a resource transfer, or the like.

“Transaction” or “resource transfer” as used herein may refer to any communication between a user and a third party merchant or individual to transfer funds for purchasing or selling of a product. A transaction may refer to a purchase of goods or services, a return of goods or services, a payment transaction, a credit transaction, or other interaction involving a user's account. In the context of a financial institution, a transaction may refer to one or more of: a sale of goods and/or services, initiating an automated teller machine (ATM) or online banking session, an account balance inquiry, a rewards transfer, an account money transfer or withdrawal, opening a bank application on a user's computer or mobile device, a user accessing their e-wallet, or any other interaction involving the user and/or the user's device that is detectable by the financial institution. A transaction may include one or more of the following: renting, selling, and/or leasing goods and/or services (e.g., groceries, stamps, tickets, DVDs, vending machine items, and the like); making payments to creditors (e.g., paying monthly bills; paying federal, state, and/or local taxes; and the like); sending remittances; loading money onto stored value cards (SVCs) and/or prepaid cards; donating to charities; and/or the like.

“Engine” as used herein may refer to core elements of a computer program, or part of a computer program that serves as a foundation for a larger piece of software and drives the functionality of the software. An engine may be self-contained, but externally controllable code that encapsulates powerful logic designed to perform or execute a specific type of function. In one aspect, an engine may be underlying source code that establishes file hierarchy, input and output methods, and how a specific part of a computer program interacts or communicates with other software and/or hardware. The specific components of an engine may vary based on the needs of the specific computer program as part of the larger piece of software. In some embodiments, an engine may be configured to retrieve resources created in other computer programs, which may then be ported into the engine during specific operational aspects of the engine. An engine may be configurable to be implemented within any general purpose computing system. In doing so, the engine may be configured to execute source code embedded therein to control specific features of the general purpose computing system to execute specific computing operations, thereby transforming the general purpose system into a specific purpose computing system.

An “adapted delayed trigger resource” as used herein may be a resource distribution for a product or service purchase that is split into future intervals, such as buy now pay later products or services. As such, in response to a trigger, an adapted delayed trigger resource may be generated comprising an automated timer component structured to monitor an elapsed program time associated with the adapted delayed trigger resource. In response to determining that (i) the current elapsed program time associated with the adapted delayed trigger resource is above a predetermined threshold, and (ii) the second time interval precedes the current elapsed program time, automatically trigger, via the adapted delayed trigger resource, transmission of a resource quantity from a user resource to an entity resource at a third time interval succeeding the second time interval.

The invention utilizes machine learning to perform an obligation extraction and population with real-time pre-endorsement matrix. The system performs two functions with respect to adapted delayed trigger resource distributions. First, the system performs a right of real-time modification of an adapted delayed trigger resource distribution occurring between a user and product producer. Second, the system performs a right to extend financial opportunities to a user bases on user historic adapted delayed trigger resource distribution obligation satisfaction.

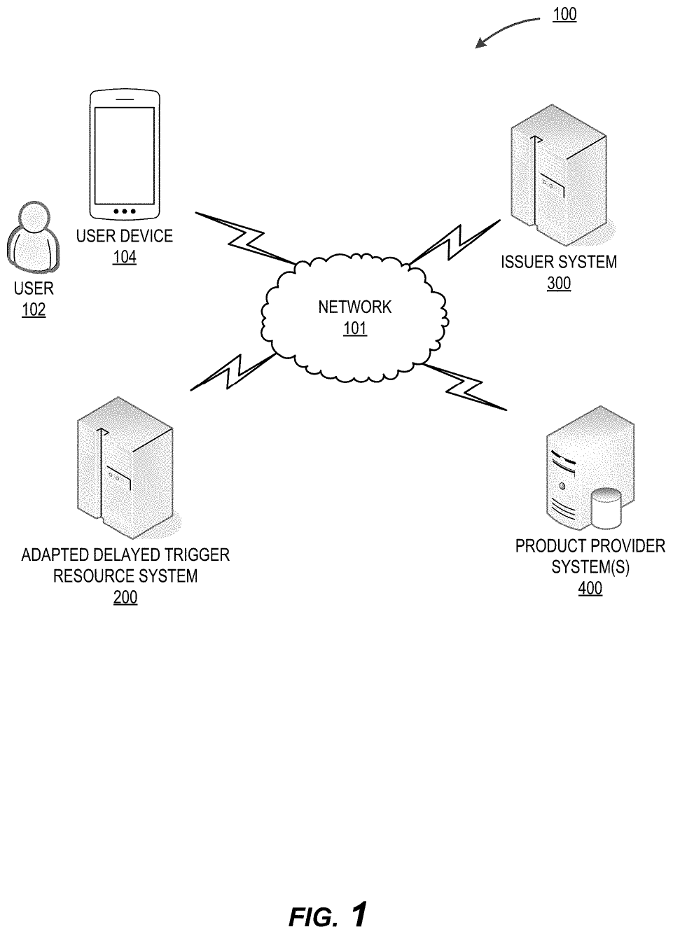

FIG. 1 illustrates an adapted delayed trigger resource pre-endorsement matrix system environment 100, in accordance with one embodiment of the present disclosure. As illustrated, the system environment 100 may comprise a user device 104 in operative communication with one or more product provider systems 400 via a network 101. The system environment also includes a user 102, a issuer system 300, a adapted delayed trigger resource system 200, and/or other systems/devices not illustrated herein and connected via a network 101. As such, the user device 104 is configured such that the user 102 may access, log in to, and/or communicate with the product provider system(s) 400 by establishing operative communication channels between the user device 104, the issuer system 300, and the product provider system(s) 400 via a wireless network.

Typically, the adapted delayed trigger resource system 200 is in operative communication with the product provider system 400, via the network 101, which may be the internet, an intranet or the like. In FIG. 1, the network 101 may include a local area network (LAN), a wide area network (WAN), a global area network (GAN), and/or near field communication (NFC) network. The network 101 may provide for wireline, wireless, or a combination of wireline and wireless communication between devices in the network. In some embodiments, the network 101 includes the Internet. In some embodiments, the network 101 may include a wireless telephone network. Furthermore, the network 101 may comprise wireless communication networks to establish wireless communication channels such as a contactless communication channel and a near field communication (NFC) channel (for example, in the instances where communication channels are established between the user device 104 and the product provider system(s) 400). In this regard, the wireless communication channel may further comprise near field communication (NFC), communication via radio waves, communication through the internet, communication via electromagnetic waves and the like.

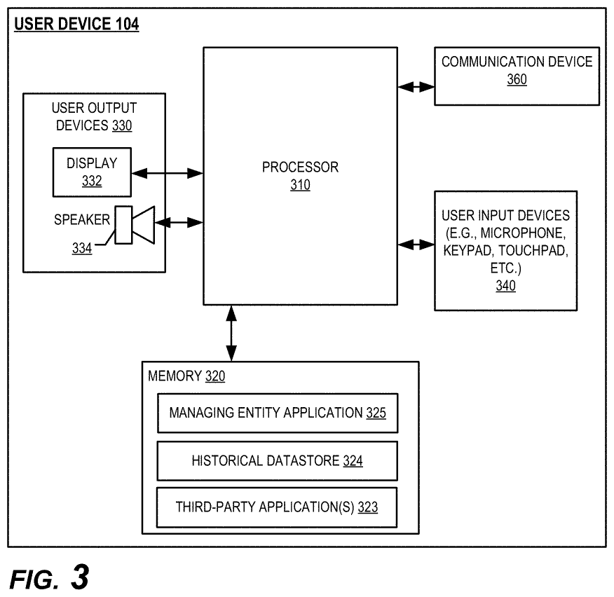

The user device 104 may comprise a mobile communication device, such as a cellular telecommunications device (i.e., a smart phone or mobile phone), a computing device such as a laptop computer, a personal digital assistant (PDA), a mobile internet accessing device, or other mobile device including, but not limited to portable digital assistants (PDAs), pagers, mobile televisions, laptop computers, cameras, video recorders, audio/video player, radio, GPS devices, any combination of the aforementioned, or the like. The user device is described in greater detail with respect to FIG. 3.

The issuer system 300 may comprise a communication module and memory not illustrated and may be configured to establish operative communication channels with the product provider system(s) 400 and a user device 104 via a network 101. The managing entity may comprise a user data repository which stores user account and/or user historical data. This data may be used by the managing entity to authenticate communications between the user device 104 and the product provider system(s) 400. In some embodiments, the managing entity system is in operative communication with the adapted delayed trigger resource system 200 via a private communication channel. The private communication channel may be via a network 101 or the adapted delayed trigger resource system 200 may be fully integrated within the product provider system 400.

The product provider system 400 may be associated with a product or service provider that is providing a user an adapted delayed trigger resource program associated with the product or service. In this way, the product provider system 400 may comprise the terms, trigger times, conditions, and the like associated with the adapted delayed trigger resource program.

The issuer system 300 may be associated with a financial institution associated with or issuing the resource distribution method used for providing the resources at the triggered times for the adapted delayed trigger resource program. Furthermore, the issuer system 300 may include additional products and accounts available associated with financial institution services.

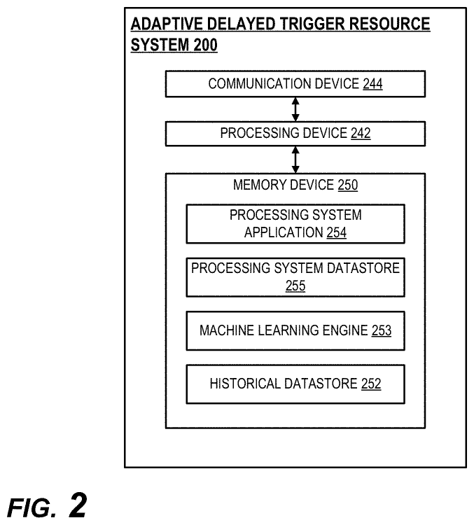

FIG. 2 illustrates a block diagram of the adapted delayed trigger resource system 200 associated with the operating environment 100, in accordance with embodiments of the present invention. As illustrated in FIG. 2, the adapted delayed trigger resource system 200 may include a communication device 244, a processing device 242, and a memory device 250 having a historical datastore 252, a machine learning engine 253, a processing system application 254 and a processing system datastore 255 stored therein. As shown, the processing device 242 is operatively connected to and is configured to control and cause the communication device 244, and the memory device 250 to perform one or more functions described herein. In some embodiments, the machine learning engine 253 and/or the processing system application 254 comprises computer readable instructions that when executed by the processing device 242 cause the processing device 242 to perform one or more functions and/or transmit control instructions to the issuer system 300, the product provider system(s) 400, and/or the communication device 244. It will be understood that the machine learning engine 253 and/or the processing system application 254 may be executable to initiate, perform, complete, and/or facilitate one or more portions of any embodiments described and/or contemplated herein, and specifically embodiments directed to obligation extraction and population of a pre-endorsement matrix determination and utilization. The machine learning engine 253 may comprise executable instructions associated with generation and encryption of authentication tokens and may be embodied within the processing system application 254 in some instances. The adapted delayed trigger resource system 200 may be owned by, operated by and/or affiliated with the same managing entity that owns or operates the issuer system 300. In some embodiments, the adapted delayed trigger resource system 200 is fully integrated within the issuer system 300.

The communication device 244 may generally include a modem, server, transceiver, and/or other devices for communicating with other devices on the network 101. The network communication device 244 may be a communication interface having one or more communication devices configured to communicate with one or more other devices on the network 101, such as the adapted delayed trigger resource system 200, the user device 104, other processing systems, data systems, and the like.

Additionally, referring to the adapted delayed trigger resource system 200 illustrated in FIG. 2, the processing device 242 may generally refer to a device or combination of devices having circuitry used for implementing the communication and/or logic functions of the adapted delayed trigger resource system 200. For example, the processing device 242 may include a control unit, a digital signal processor device, a microprocessor device, and various analog-to-digital converters, digital-to-analog converters, and other support circuits and/or combinations of the foregoing. Control and signal processing functions of the system 200 may be allocated between these processing devices according to their respective capabilities. The processing device 242 may further include functionality to operate one or more software programs based on computer-executable program code thereof, which may be stored in a memory device 250, such as the processing system application 254 and the machine learning engine 253. As the phrase is used herein, a processing device may be “configured to” perform a certain function in a variety of ways, including, for example, by having one or more general-purpose circuits perform the function by executing particular computer-executable program code embodied in computer-readable medium, and/or by having one or more application-specific circuits perform the function. The processing device 242 may be configured to use the network communication interface of the communication device 244 to transmit and/or receive data and/or commands to and/or from the other devices/systems connected to the network 101.

The memory device 250 within the adapted delayed trigger resource system 200 may generally refer to a device or combination of devices that store one or more forms of computer-readable media for storing data and/or computer-executable program code/instructions. For example, the memory device 250 may include any computer memory that provides an actual or virtual space to temporarily or permanently store data and/or commands provided to the processing device 242 when it carries out its functions described herein.

FIG. 3 illustrates a block diagram of the user device associated with the system environment 104, in accordance with embodiments of the present invention. The user device 104 may include a user mobile device or the like. A “mobile device” 104 may be any mobile communication device, such as a cellular telecommunications device (i.e., a cell phone or mobile phone), personal digital assistant (PDA), a mobile Internet accessing device, or another mobile device including, but not limited to portable digital assistants (PDAs), pagers, mobile televisions, laptop computers, cameras, video recorders, audio/video player, radio, GPS devices, any combination of the aforementioned devices.

The mobile device 104 may generally include a processing device or processor 310 communicably coupled to devices such as, a memory device 320, user output devices 330 (for example, a user display device 332, or a speaker 334), user input devices 340 (such as a microphone, keypad, touchpad, touch screen, fingerprint scanner, camera, and/or the like), a communication device or network interface device 360, one or more chips, and the like.

The processor 310 may include functionality to operate one or more software programs or applications, which may be stored in the memory device 320. For example, the processor 310 may be capable of operating applications such as the managing entity application 325, one or more third party applications 323, a historical datastore 324, or a web browser application. The managing entity application 325 may then allow the mobile device 104 to transmit and receive data and instructions to or from the issuer system 300 (for example, via wireless communication or NFC channels), data and instructions to or from the processing system 200, web content, such as, for example, location-based content and/or other web page content, according to a Wireless Application Protocol (WAP), Hypertext Transfer Protocol (HTTP), and/or the like.

The processor 310 may be configured to use the communication device 360 to communicate with one or more other devices on a network 101 such as, but not limited to the issuer system 300 and the adapted delayed trigger resource system 200. The processor 310 may be configured to provide signals to and receive signals from the communication device 360. The signals may include signaling information in accordance with the air interface standard of the applicable BLE standard, cellular system of the wireless telephone network and the like, that may be part of the network 101. In this regard, the mobile device 104 may be configured to operate with one or more air interface standards, communication protocols, modulation types, and access types. By way of illustration, the mobile device 104 may be configured to operate in accordance with any of a number of first, second, third, and/or fourth-generation communication protocols and/or the like. For example, the mobile device 104 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols, and/or the like. The mobile device 104 may also be configured to operate in accordance with non-cellular communication mechanisms, such as via a wireless local area network (WLAN) or other communication/data networks. The mobile device 104 may also be configured to operate in accordance Bluetooth® low energy, audio frequency, ultrasound frequency, or other communication/data networks.

The communication device 360 may also include a user activity interface presented in user output devices 330 in order to allow a user 102 to execute some or all of processes described herein. Furthermore, the application interface may have the ability to connect to and communicate with an external data storage on a separate system within the network 101. As described above, the mobile device 104 includes a user interface that includes user output devices 330 and/or user input devices 340. The user output devices 330 may include a display 332 (e.g., a liquid crystal display (LCD) or the like) and a speaker 334 or other audio device, which are operatively coupled to the processor 310. The user input devices 340, which may allow the mobile device 104 to receive data from the user 102, may include any of a number of devices allowing the mobile device 104 to receive data from a user 102, such as a keypad, keyboard, touch-screen, touchpad, microphone, mouse, joystick, other pointer device, button, soft key, and/or other input device(s).

The mobile device 104 may also include a memory buffer, cache memory or temporary memory device operatively coupled to the processor 310. Typically, one or more applications 325, 324, and 323, are loaded into the temporary memory during use. As used herein, memory may include any computer readable medium configured to store data, code, or other information. The memory device 320 may include volatile memory, such as volatile Random Access Memory (RAM) including a cache area for the temporary storage of data. The memory device 420 may also include non-volatile memory, which can be embedded and/or may be removable. The non-volatile memory may additionally or alternatively include an electrically erasable programmable read-only memory (EEPROM), flash memory or the like.

In some instances, various features and functions of the invention are described herein with respect to a “system.” In some instances, the system may refer to the adapted delayed trigger resource system 200 performing one or more steps described herein in conjunction with other devices and systems, either automatically based on executing computer readable instructions of the memory device 250, or in response to receiving control instructions from the issuer system 300. In some instances, the system refers to the devices and systems on the operating environment 100 of FIG. 1. The features and functions of various embodiments of the invention are be described below in further detail.

It is understood that the servers, systems, and devices described herein illustrate one embodiment of the invention. It is further understood that one or more of the servers, systems, and devices can be combined in other embodiments and still function in the same or similar way as the embodiments described herein.

Adapted delayed trigger resource distribution methods are a relatively new and small portion of resource transactions. However, adapted delayed trigger resource programs are gaining in popularity as a way to reduce a user's up-front obligation and spread that obligation over a period of time. Unlike loan products, adapted delayed trigger resource distribution programs are less regulated, do not require background confirmations, and are generally performed directly by the product provider. As such, financial institutions may be susceptible to adapted delayed trigger resource distribution program terms that are unknown. Furthermore, if obligations of the adapted delayed trigger resource distribution product are not met, the issuing institution associated with the resource distribution device may be susceptible. As such, a need exists for obligation extraction and population with a real-time pre-endorsement matrix.

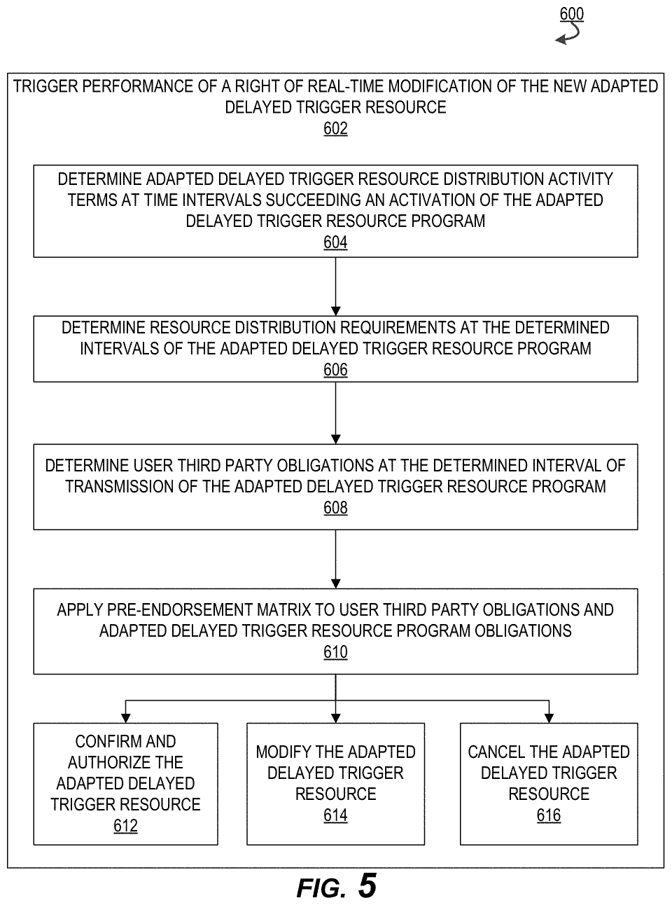

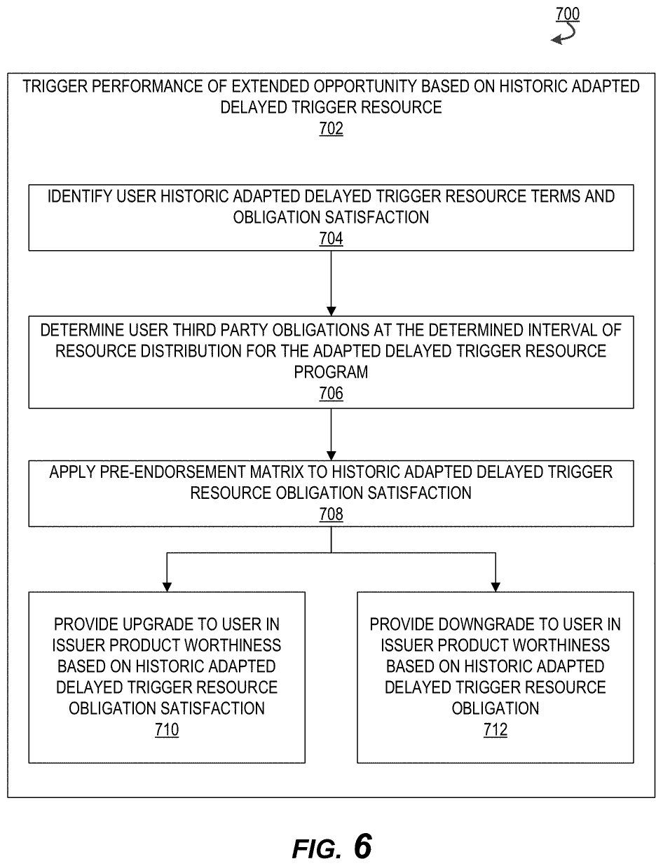

The invention utilizes machine learning to perform an obligation extraction and population with real-time pre-endorsement matrix. The system performs two functions with respect to adapted delayed trigger resource distributions. First, the system performs a right of real-time modification of an adapted delayed trigger resource distribution occurring between a user and product producer, described in further detail below with respect to FIG. 5. Second, the system performs a right to extend financial opportunities to a user bases on user historic adapted delayed trigger resource distribution obligation satisfaction, described in further detail below with respect to FIG. 6.

In this way, the system utilized artificial intelligence (AI) in combination with machine learning analytics to perform approval, modification, denial of an adaptive delayed trigger resource requirement and provide future opportunities based on user adaptive delayed trigger resource requirement history. Issuing entities, such as financial institutions, currently do not monitor terms or obligations associated with adaptive delayed trigger resource requirement programs. Due to the fragmented nature of adaptive delayed trigger resource requirement program providers, managing adaptive delayed trigger resource requirement program obligations can become challenging, which may result in unexpected exposure for issuing entities and users.

Furthermore, the system may aggregate and estimate a user's obligations for adaptive delayed trigger resource requirement programs to determine users likely ability to perform the obligations. Furthermore, the system provides user alerts with respect to total adaptive delayed trigger resource requirement program obligations.

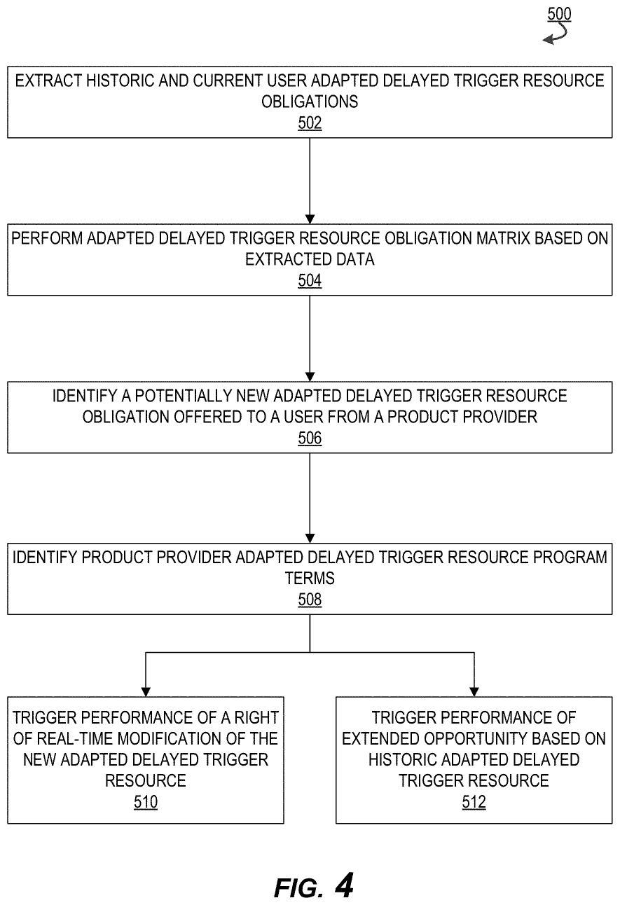

FIG. 4 is a high-level process flow diagram illustrating a process of obligation extraction and population 500, in accordance with one embodiment of the present disclosure. As illustrated in block 502, the process 500 is initiated by extracting historic and current user adapted delayed trigger resource obligations. The system may be associated with an issuer that issues the resource distribution product used to complete adapted delayed trigger resource programs the user may have had in the past. The system may be able to identify reoccurring payments from one or more resource distribution accounts. In this way, the system may review prior payments to identify one or more adapted delayed trigger resource program obligations that the user may have had. In some embodiments, the user may provide the system with the user historic and current user adapted delayed trigger resource obligations. In some embodiments, the system may also identify and determine one or more terms associated with adapted delayed trigger resource programs.

In this way, the system may receive, from a device/POS associated with a first entity, data associated with an activity initiated by a user at a first time interval, wherein the activity comprises an adapted delayed trigger resource obligation which includes a required distribution of resources at one or more future time intervals. In this way, in response to a trigger, a product producer or third party may construct an adapted delayed trigger resource comprising an automated timer component structured to monitor an elapsed program time associated with the adapted delayed trigger resource. Upon user acceptance, the product producer or third party processes the activity data and complete the activity at a second time interval succeeding the first time interval based on activating/implementing the adapted delayed trigger resource. Next, in response to determining that (i) the current elapsed program time associated with the adapted delayed trigger resource is above a predetermined threshold, and (ii) the second time interval precedes the current elapsed program time, automatically trigger, via the adapted delayed trigger resource, transmission of a resource quantity from a user resource to an entity resource at a third time interval succeeding the second time interval.

As illustrated in block 504, the process 500 continues by performing adapted delayed trigger resource pre-endorsement matrix based on extracted data. The pre-endorsement matrix includes the extracted data associated with the user adapted delayed trigger resource obligations, user total resource distribution obligations (outside of adapted delayed trigger resource programs), user historic repayment of adapted delayed trigger resource programs, and user total resource intake. Using AI and machine learning, the system continually inputs these data points to generate a pre-endorsement matrix. The pre-endorsement matrix provides a fluid dynamic evaluator of new adapted delayed trigger resource programs (and the terms associated therewith) the user may be interested in and the likelihood of satisfying the resource distribution requirements of those adapted delayed trigger resource programs in the future. The pre-endorsement matrix includes a feedback loop of each recurring resource distribution of a user associated with an adapted delayed trigger resource obligation of the user and continually monitors user satisfaction of the obligations.

Next, as illustrated in block 506, the process 500 continues by identifying a potentially new adapted delayed trigger resource obligation offered to a user from a product provider. In some embodiments, the system may be able to identify a transaction that is being initiated or processed from one or more product providers that are known by the system to provide adapted delayed trigger resource programs to a user. In this way, the system may identify the product provider attempting to process a transaction with a user through issuer provided resource distribution vehicles. In some embodiments, the user or product provider may communicate with the system to provide an indication of a transaction comparison an adapted delayed trigger resource program to the user for completion of a transaction for the purchase of a product or service. The system may further determine the terms of the adapted delayed trigger resource program offered by the product provider, as illustrated in block 508. The terms may include timing of resource distributions, amount of resource distribution, number of resource distributions, and the like. In this way, the system identifies the triggers, time intervals, and the like for the adapted delayed trigger resource program for the specific product and product provider associated with a user transaction.

The pre-endorsement matrix generated allows for system performance of two functions with respect to adapted delayed trigger resource distributions. The invention utilizes machine learning to perform an obligation extraction and population with real-time pre-endorsement matrix. The system performs two functions with respect to adapted delayed trigger resource distributions. First, the system performs a right of real-time modification of an adapted delayed trigger resource distribution occurring between a user and product producer, as illustrated in block 510 and further described below in FIG. 5. Second, the system performs a right to extend financial opportunities to a user bases on user historic adapted delayed trigger resource distribution obligation satisfaction, as illustrated in block 512 and further described below in FIG. 6.

FIG. 5 is a flow diagram illustrating a process of modifying an adapted delayed trigger resource 600, in accordance with another embodiment of the present disclosure. As illustrated, the process 600 provides a trigger of performance of a right of real-time modification of a new adapted delayed trigger resource, as illustrated in block 602. In this way, the system performs a right of real-time modification of an adapted delayed trigger resource distribution occurring between a user and product producer.

In order to modify an adapted delayed trigger resource, the system may first identify a potentially new adapted delayed trigger resource obligation being offered to a user from a product provider. In some embodiments, the system may be able to identify a transaction that is being initiated or processed from one or more product providers that are known by the system to provide adapted delayed trigger resource programs to a user. In this way, the system may identify the product provider attempting to process a transaction with a user through issuer provided resource distribution vehicles. In some embodiments, the user or product provider may communicate with the system to provide an indication of a transaction comparison an adapted delayed trigger resource program to the user for completion of a transaction for the purchase of a product or service.

As illustrated in block 604, the process 600 is initiated by determining an adapted delayed trigger resource distribution activity terms from the product provider. This includes determining payment terms, obligations, missed obligation terms, timing of payment, types of payments required, and the like. Furthermore, this includes determining the time intervals succeeding an activation of the adapted delayed trigger resource program. As illustrated in block 606 the system determines the resource distribution requirements at each of the intervals of the adapted delayed trigger resource program. These resource distributions are the times and amounts that the user may be responsible for resource distribution.

Next, as illustrated in block 608, the process 600 continues by determining user third party obligations at the determined intervals of transmission of the adapted delayed trigger resource program. In this way, the system identifies if the user has other adapted delayed trigger resource programs due, other resource obligations, or the like at each determined interval. In this way, the system may determine if the user is over obligated for resource distribution at each determined interval in the future.

As illustrated in block 610, the process 600 continues by applying the pre-endorsement matrix to the user third party obligations and adapted delayed trigger resource program obligations. Furthermore, the pre-endorsement matrix may include user resource intake, user typical resource obligations, user historical obligation satisfactions, and the like. The pre-endorsement matrix may apply machine learning to the data to learn user pre-endorsement or non-endorsement of the current adapted delayed trigger resource program that the user is applying for, in real-time.

Based on the pre-endorsement matrix output, the system may confirm and authorize the adapted delayed trigger resource program that the user is currently entering into with a product provider, as illustrated in block 612. In this way, the system identifies the user is entering into an adapted delayed trigger resource program with a product provider, applies the terms of the program to the pre-endorsement matrix along with the other user data to determine and approve the user for the adapted delayed triggered resource. The system may communicate the authorization to the product provider and/or the user system for processing.

Based on the pre-endorsement matrix output, the system may modify the adapted delayed trigger resource program that the user is currently entering into with a product provider, as illustrated in block 614. In this way, the system identifies the user is entering into an adapted delayed trigger resource program with a product provider, applies the terms of the program to the pre-endorsement matrix along with the other user data to determine that a modification of the adapted delayed triggered resource program is necessary. The system may communicate the proposed modification to the terms (such as the timing of the intervals, the amount of resources associated with the intervals, or the like) to the product provider and/or the user system for processing.

Based on the pre-endorsement matrix output, the system may cancel the adapted delayed trigger resource program that the user is currently entering into with a product provider, as illustrated in block 616. In this way, the system identifies the user is entering into an adapted delayed trigger resource program with a product provider, applies the terms of the program to the pre-endorsement matrix along with the other user data to determine and cancel the user for the adapted delayed triggered resource. The system may communicate the cancelation to the product provider and/or the user system for processing.

FIG. 6 is a flow diagram illustrating a process of performance extension based on historic adapted delayed trigger resource 700, in accordance with another embodiment of the present disclosure. As illustrated, FIG. 6 provides a trigger performance of extended opportunity based on historic adapted delayed trigger resource obligation satisfaction, as illustrated in block 702. In this way, the system may review a user's historic adapted delayed trigger resource programs and provide a worthiness of new adapted delayed trigger resource or other resource products based on successful fulfillment of historic adapted delayed trigger resource programs. As such, this may provide an alternative to typical resource lending scoring or the like and allow for otherwise unqualified users to qualify for resource products based on historic satisfaction of adapted delayed trigger resource programs.

As illustrated in block 704, the process 700 is initiated by identifying user historic adapted delayed trigger resource programs, the terms of those programs, and whether the user satisfied the obligations associated with the terms of those programs. In this way, the system may extract and review issuer data to identify payment posting, rail processing, and the like of any potential resource distribution to a product provider.

Next, as illustrated in block 706, the process 700 continues by determining user third party obligations at the determined intervals for the resource distribution for the adapted delayed trigger resource program. In this way, the system identifies the historic intervals of resource distribution requirements for the history adapted delayed trigger resource programs that the user has previously been enrolled in. The system determines the other third party resource distribution obligations the user may have at that time. These third party obligations may include reoccurring invoices, other resource distribution obligations, such as payment of payment devices, or the like. These third party obligations in addition to the adapted delayed trigger resource program obligations the user had at a specific time period gives a wholistic view of user ability to meet additional or future resource distribution obligations.

As illustrated in block 708, the process 700 continues by applying the pre-endorsement matrix to the historic adapted delayed trigger resource obligation satisfaction, user third party obligations and future adapted delayed trigger resource program obligations. Furthermore, the pre-endorsement matrix may include user resource intake, user typical resource obligations, user historical obligation satisfactions, and the like. The pre-endorsement matrix may apply machine learning to the data to learn user pre-endorsement or non-endorsement of the current adapted delayed trigger resource program that the user is applying for, in real-time. The pre-endorsement matrix provides a machine learning graphical interface of likelihood of satisfaction of future adapted delayed trigger resource programs. In some embodiments, the pre-endorsement matrix triggers extended opportunities to a user based on historic adapted delayed trigger resource obligation satisfaction.

As illustrated in block 710, the system may provide an upgrade to the user with respect to issuer product worthiness based on historic adapted delayed trigger resource obligation satisfaction. In this way, irrespective of other financial scores, the system may increase the user's financial institution product worthiness based on historic adapted delayed trigger resource obligation satisfaction. As such, as the system identifies a user that continually satisfies these obligations, the system communicates that with a financial institution that may provide offers of products to the user based on this satisfaction instead of based on other financial scores or factors.

As illustrated in block 712, the system may provide a downgrade to the user with respect to issuer or financial institution product worthiness based on historic adapted delayed trigger resource obligations not being met.

The invention utilizes machine learning to perform an obligation extraction and population with real-time pre-endorsement matrix. The system performs two functions with respect to adapted delay trigger resource distributions. First, the system performs a right of real-time modification of an adapted delay trigger resource distribution occurring between a user and product producer. Second, the system performs a right to extend financial opportunities to a user bases on user historic adapted delay trigger resource distribution obligation satisfaction.

In this way, the system uses AI and machine learning to generate a pre-endorsement matrix to determine analytics for approving or rejecting adapted delayed trigger resource distribution purchases (buy now pay later (BNPL)) based on users total expected obligations. Issuing entities typically are not able to visualize adapted delayed trigger resource distribution programs obligations in user's decision to approve/decline adapted delayed trigger resource distribution. Due to the fragmented nature of adapted delayed trigger resource distribution providers, managing adapted delayed trigger resource distribution obligations is challenging. As such, using the pre-endorsement matrix, the system aggregates and estimates users adapted delayed trigger resource distribution obligations to determine a user's likely ability satisfy the obligations, and make accept/decline decisioning for future adapted delayed trigger resource distribution program obligations.

The system, using the pre-endorsement matrix performs two functions. First the system allows for the right to modify or cancel, in real-time, an adapted delayed trigger resource distribution program that a user may be entering. In this way, the system may identify the name of a product provider when a transaction is being processed through a payment rail based on the merchant of record name. The system may be able to identify the terms of the product provider's adapted delayed trigger resource distribution program. Using this, and user data, the system may be able to make an estimate of the total adapted delayed trigger resource distribution program obligations for the user from multiple product providers and other obligations to determine a potential for satisfaction of the current adapted delayed trigger resource distribution program obligations. The system may be able to modify or cancel the current adapted delayed trigger resource distribution program based on the determination from the pre-endorsement matrix output. Second, the system allows for the right to extend financial institution product credits to a user, in real-time, based on user historic adapted delayed trigger resource distribution program obligation satisfaction. For example, a user may not have a financial score, but based on a history of successful adapted delayed trigger resource distribution program obligations, may allow for a user to gain access to financial institution products based on prior user success.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EEPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out the specialized operations of the present invention may be required on the specialized computer include object-oriented, scripted, and/or unscripted programming languages, such as, for example, Java, Perl, Smalltalk, C++, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F #.

Embodiments of the present invention are described above with reference to flowcharts and/or block diagrams. It will be understood that steps of the processes described herein may be performed in orders different than those illustrated in the flowcharts. In other words, the processes represented by the blocks of a flowchart may, in some embodiments, be in performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for adapted delay trigger resource modification, the system comprising:
a memory device with computer-readable program code stored thereon;
a communication device;
a processing device operatively coupled to the memory device and the communication device, wherein the processing device is configured to execute the computer-readable program code to:
extract historic and current user interval obligations, wherein user interval obligations include user adapted delayed trigger resource obligations;
receive, from a device associated with a first entity, data associated with an activity initiated by a user at a first time interval;
identify, in response to the activity initiated, that the activity initiated is an adapted delayed trigger resource program initiation comprising an automated timer component structured to monitor an elapsed program time associated with the adapted delayed trigger resource;
trigger a performance of a right of real-time modification of the adapted delayed trigger resource program;
trigger performance of historic adapted delayed trigger resource obligation mapping; and
process, based on a pre-endorsement matrix mapping:
the activity data based on the triggered performance of the right of real-time modification of the adapted delayed trigger resource program; and
a modification to issuer product worthiness based on the triggered performance of historic adapted delayed trigger resource obligation mapping.

2. The system of claim 1, wherein processing, based on the pre-endorsement matrix mapping of the activity data without real-time modification of the adapted delay trigger resource program comprises:
processing the activity data and complete the activity at a second time interval succeeding the first time interval based on not modifying the adapted delayed trigger resource program; and
in response to determining that (i) the current elapsed program time associated with the adapted delayed trigger resource program is above a predetermined threshold, and (ii) the second time interval precedes the current elapsed program time, automatically trigger, via the adapted delayed trigger resource program, transmission of a resource quantity from a user resource to an entity resource at a third time interval succeeding the second time interval.

3. The system of claim 1, wherein triggering the performance of the right of real-time modification of the adapted delayed trigger resource program further comprises performing pre-endorsement matrix mapping analyzing: (i) extracted historic and current user interval obligations and (ii) the adapted delayed trigger resource program initiation to determine user resources available at a second time interval.

4. The system of claim 3, wherein based on performing the pre-endorsement matrix mapping analysis, confirm, modify, or deny the adapted delayed trigger resource program initiation in real-time.

5. The system of claim 1, wherein triggering the performance of historic adapted delayed trigger resource obligation mapping further comprises performing pre-endorsement matrix mapping analyzing user historic adapted delayed trigger resource obligation satisfaction.

6. The system of claim 5, wherein based on performing the pre-endorsement matrix mapping analysis, upgrade or downgrade user product worthiness.

7. The system of claim 1, wherein the pre-endorsement matrix mapping further comprises machine learning analysis of data for predicted user obligation fulfilment with respect to adapted delayed trigger resources.

8. The system of claim 1, wherein the first entity is a product producing entity that offers the adapted delayed trigger resource program to the user and provides terms associated with the adapted delayed trigger resource program.

9. The system of claim 1, wherein user interval obligations further comprise reoccurring resource distributions from the user to a third party for a product or service.

10. A computer program product for adapted delay trigger resource modification with at least one non-transitory computer-readable medium having computer-readable program code portions embodied therein, the computer-readable program code portions comprising:
an executable portion configured for extracting historic and current user interval obligations, wherein user interval obligations include user adapted delayed trigger resource obligations;
an executable portion configured for receiving, from a device associated with a first entity, data associated with an activity initiated by a user at a first time interval;
an executable portion configured for identifying, in response to the activity initiated, that the activity initiated is an adapted delayed trigger resource program initiation comprising an automated timer component structured to monitor an elapsed program time associated with the adapted delayed trigger resource;
an executable portion configured for triggering a performance of a right of real-time modification of the adapted delayed trigger resource program;
an executable portion configured for triggering performance of historic adapted delayed trigger resource obligation mapping; and
an executable portion configured for processing, based on a pre-endorsement matrix mapping:
the activity data based on the triggered performance of the right of real-time modification of the adapted delayed trigger resource program; and
a modification to issuer product worthiness based on the triggered performance of historic adapted delayed trigger resource obligation mapping.

11. The computer program product of claim 10, wherein processing, based on the pre-endorsement matrix mapping of the activity data without real-time modification of the adapted delay trigger resource program comprises:
processing the activity data and complete the activity at a second time interval succeeding the first time interval based on not modifying the adapted delayed trigger resource program; and
in response to determining that (i) the current elapsed program time associated with the adapted delayed trigger resource program is above a predetermined threshold, and (ii) the second time interval precedes the current elapsed program time, automatically trigger, via the adapted delayed trigger resource program, transmission of a resource quantity from a user resource to an entity resource at a third time interval succeeding the second time interval.

12. The computer program product of claim 10, wherein triggering the performance of the right of real-time modification of the adapted delayed trigger resource program further comprises performing pre-endorsement matrix mapping analyzing: (i) extracted historic and current user interval obligations and (ii) the adapted delayed trigger resource program initiation to determine user resources available at a second time interval.

13. The computer program product of claim 13, wherein based on performing the pre-endorsement matrix mapping analysis, confirm, modify, or deny the adapted delayed trigger resource program initiation in real-time.

14. The computer program product of claim 10, wherein triggering the performance of historic adapted delayed trigger resource obligation mapping further comprises performing pre-endorsement matrix mapping analyzing user historic adapted delayed trigger resource obligation satisfaction.

15. The computer program product of claim 14, wherein based on performing the pre-endorsement matrix mapping analysis, upgrade or downgrade user product worthiness.

16. The computer program product of claim 10, wherein the pre-endorsement matrix mapping further comprises machine learning analysis of data for predicted user obligation fulfilment with respect to adapted delayed trigger resources.

17. A computer-implemented method for adapted delay trigger resource modification, the method comprising:
providing a computing system comprising a computer processing device and a non-transitory computer readable medium, where the computer readable medium comprises configured computer program instruction code, such that when said instruction code is operated by said computer processing device, said computer processing device performs the following operations:
extracting historic and current user interval obligations, wherein user interval obligations include user adapted delayed trigger resource obligations;
receiving, from a device associated with a first entity, data associated with an activity initiated by a user at a first time interval;
identifying, in response to the activity initiated, that the activity initiated is an adapted delayed trigger resource program initiation comprising an automated timer component structured to monitor an elapsed program time associated with the adapted delayed trigger resource;
triggering a performance of a right of real-time modification of the adapted delayed trigger resource program;
triggering performance of historic adapted delayed trigger resource obligation mapping; and
processing, based on a pre-endorsement matrix mapping:
the activity data based on the triggered performance of the right of real-time modification of the adapted delayed trigger resource program; and
a modification to issuer product worthiness based on the triggered performance of historic adapted delayed trigger resource obligation mapping.

18. The computer-implemented method of claim 17, wherein processing, based on the pre-endorsement matrix mapping of the activity data without real-time modification of the adapted delay trigger resource program comprises:
processing the activity data and complete the activity at a second time interval succeeding the first time interval based on not modifying the adapted delayed trigger resource program; and
in response to determining that (i) the current elapsed program time associated with the adapted delayed trigger resource program is above a predetermined threshold, and (ii) the second time interval precedes the current elapsed program time, automatically trigger, via the adapted delayed trigger resource program, transmission of a resource quantity from a user resource to an entity resource at a third time interval succeeding the second time interval.

19. The computer-implemented method of claim 17, wherein triggering the performance of the right of real-time modification of the adapted delayed trigger resource program further comprises performing pre-endorsement matrix mapping analyzing: (i) extracted historic and current user interval obligations and (ii) the adapted delayed trigger resource program initiation to determine user resources available at a second time interval and, wherein based on performing the pre-endorsement matrix mapping analysis, confirm, modify, or deny the adapted delayed trigger resource program initiation in real-time.

20. The computer-implemented method of claim 17, wherein triggering the performance of historic adapted delayed trigger resource obligation mapping further comprises performing pre-endorsement matrix mapping analyzing user historic adapted delayed trigger resource obligation satisfaction and, wherein based on performing the pre-endorsement matrix mapping analysis, upgrade or downgrade user product worthiness.
